(19) United States
(12) Patent Application Publication
(10) Pub. No.: US 2006/0212878 A1
(43) Pub. Date: Sep. 21, 2006

(54) Method for reconfiguring application using subtyping-based flexible service adaptation in pervasive computing environment and system thereof

(75) Inventors: Kyung-ho Park, Suwon (KR); Woo-shik Kang, Suwon (KR); Seung-hyun Han, Daejeon-si (KR); Kyung-min Lee, Daejeon-si (KR); Dong-man Lee, Daejeon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRO-MECHANICS CO., LTD.

(21) Appl. No.: 11/349,169

(22) Filed: Feb. 8, 2006

(30) Foreign Application Priority Data
Feb. 14, 2005 (KR) 10-2005-0011946

(51) Int. Cl. G06F 9/46

(52) U.S. Cl. 719/319

(57) ABSTRACT

A method for reconfiguring an application in a pervasive computing environment, includes receiving a request for a reconfiguration of a predetermined application reconfiguration according to a change in a context, searching a service in response to the change in the context with respect to each of at least one service component configuring the predetermined application, and reconfiguring the predetermined application based on the searched service.

### CROSS-REFERENCED TO RELATED APPLICATIONS

This application claims priority from Korean Patent Application No 10-2005-0011946, filed on Feb. 14, 2005, in the Korean Intellectual Property Office, the disclosure of which is incorporated herein in its entirety.

### BACKGROUND OF THE INVENTION

1. Field of the Invention

The present invention relates to a method for reconfiguring an application, and more particularly, to a method for reconfiguring an application transparently in response to a change in a context of a pervasive computing environment.

2. Description of the Related Art

With the ubiquity of networks and computing devices, pervasive computing will become a reality in the near future. One of the goals of pervasive computing is a system that transparently supports a user so that the user can continue to perform his/her current task at a minimum overhead although changes in a context occur for various reasons.

In order to support this transparency, the pervasive computing systems have to be aware of a user's request in advance and reconfigure an application with a service that is available when the user moves to a new environment.

There are conventional systems to support the dynamic application reconfiguration in the pervasive environment. Representative systems are Gaia and Aura. These conventional systems aim to support an application reconfiguration according to displacement of an application and a task. The main idea of these systems is to describe an application abstractly and independently from an environment and thus enable the application to be adapted to any other different environment.

The Gaia system deals with application mobility between active spaces that include various heterogeneous devices. The application in the active space is configured of a combination of distributed components and is described as an application generic description (AGD) that is independent from the active space. The application is initialized and executed by an application customized description (ACD) that describes the AGD as a resource usable in each environment. The Gaia system attempted to address a problem of heterogeneity in various environments but eventually focused on the heterogeneity of devices rather than those of services. In other words, the Gaia system assumes that the services used as components of the application in all active spaces are all usable.

However, this assumption is not suitable for the pervasive computing environment. That is, there has been a demand for a system that enables an application to be dynamically adapted even if a same service is not available in a new environment and solves the problem of the heterogeneity of services. However, the Gaia system does not consider the heterogeneity of services.

The Aura system supports task mobility. Herein, the task refers to a unit that is configured of a union of various abstracted services and is described independently from the environment. The services are realized in each environment and support the task. For example, the task ‘writing edit’ is performed by MSWord or Notepad in the window environment and performed by Vi or Emace in the Unix or Linux environment. The Aura system attempts to solve the problem of homogeneity from a point of service and an operating system. However, the Aura system disregards a functional similarity or a functional conformance between services. For example, the Notepad does not provide the same function as that of MSWord. Also, the Aura system is disadvantageous in that a user has to use two services having no functional conformance, individually and adaptively, and also does not guarantee a functional conformance between substitutable services.

Approaches used in the Gaia and Aura systems have the problem that when a user moves to a new environment, the user is unable to find the same service. In particular, when a user moved to a new environment the user just wants to find the same service as an existing service or a similar one. However, if there is no same service, but the user wants to find the same service, these systems fail to reconfigure an application. This means that the user directly selects a service to reconfigure the application. If a similar service is substituted for the existing service, these systems cannot guarantee that the substituted service provides the same functions desired by the user.

Meanwhile, the component-based software engineering (CBSE) field has already suggested various approaches to support a flexible service adaptation in a different environment. The CBSE field uses a method for finding a substitutable service by analyzing and comparing a meaning of the service to reconfigure components of the application. This method is suitable for a broad range area and very flexible, but requires service providers to specifically describe the operations of services. The ‘sub-typing’ is to substitute for the existing components. The notion of ‘behavior sub-typing’ describes operations of the services and thus makes it possible to semantically substitute the operations of ‘sub-type’ and ‘super-type’.

A conventional ‘behavior sub-typing’-based approach does not place a limitation on a hierarchical relationship between services when finding a substitutable service. That is, even if there is no sub-type of the requested service, the conventional approach finds a service having a similar operation. This method also requires the service provider to specifically describe the operations of the services. Also, there still remains a problem that a complete functional conformance of the substituted service with respect to the existing service is not guaranteed.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

The present invention provides a method for transparently reconfiguring an application according to a change in a context in a pervasive computing environment, and a system thereof.

According to an aspect of the present invention, there is provided a method for reconfiguring an application in a pervasive computing environment, including receiving a request for a reconfiguration of a predetermined application reconfiguration according to a change in a context, searching a service in response to the change in the context with respect to each of at least one service component configuring the predetermined application, and reconfiguring the predetermined application based on the searched service.

Preferably, but not necessarily, the service searching operation includes searching a service that provides the same operation as that of the service component, and if there is no service providing the same operation as that of the service component, searching for a substitutable service.

Preferably, but not necessarily, the substitutable service is based on a ‘behavior sub-typing’ notion, and the substitutable service is determined in one of a substitution with a sub-type method, a substitution with a super-type method, and a coercion with a super-type method.

Preferably, but not necessarily, the change in the context occurs due to one of a user moving to a new environment, a device dynamically appearing, and a service dynamically appearing.

According to another aspect of the present invention, there is provided an application reconfiguration system which reconfigures an application according to a change in a context in a pervasive computing environment, including a service container that stores information about at least one service component configuring a predetermined application, a substitution policy decision part that searches service information in response to the change in the context with respect to the service component, and a mapping table that stores a mapping information between the service component and the corresponding service information.

Preferably, but not necessarily, the application reconfiguration system further includes a type repository that stores information necessary to search the service information.

Preferably, but not necessarily, the application reconfiguration system further includes an event translation module that processes a request for an execution of the predetermined application according to the mapping information stored in the mapping table.

Preferably, but not necessarily, the substitution policy decision part searches for a service that provides the same operation as that of the service component, and if there is no service providing the same operation as that of the service component, searches for a substitutable service.

Preferably, but not necessarily, the substitutable service is based on a ‘behavior sub-typing’ notion, and the substitutable service is determined in one of a substitution with a sub-type method, a substitution with a super-type method, and a coercion with a super-type method.

Preferably, but not necessarily, the change in the context occurs due to one of a user moving to a new environment, a device dynamically appearing, and that a service dynamically appearing.

### BRIEF DESCRIPTION OF THE DRAWINGS

The above and/or other aspects of the present invention will become apparent and more readily appreciated from the following description of the exemplary embodiments, taken in conjunction with the accompanying drawings of which:

FIG. 1 is a block diagram illustrating an application reconfiguration system according to an exemplary embodiment of the present invention;

FIG. 2 is a flowchart showing a message transferring process to explain a method for reconfiguring an application according to an exemplary embodiment of the present invention;

FIG. 3 is an entire class diagram used in the application reconfiguration system according to an exemplary embodiment of the present invention;

FIG. 4 is a class diagram of the event translation module of FIG. 1;

FIG. 5 is a flowchart showing a message transferring process of the event translation module of FIG. 1;

FIG. 6 is a class diagram of the type repository of FIG. 1; and

FIGS. 7 and 8 are views illustrating the method for reconfiguring an application according to an exemplary embodiment of the present invention that is applied to a smart electric lamp by way of example.

### DETAILED DESCRIPTION OF EXEMPLARY EMBODIMENTS

Hereinafter, exemplary embodiments of the present invention will now be described in greater detail with reference to the accompanying drawings.

According to a conventional method for reconfiguring an application, if there is no same service as a requested service in a new environment, a user finds a similar service or directly selects the service of an application. A method for reconfiguring an application according to an exemplary embodiment of the present invention uses a flexible service reconfiguration technique that adopts the notion of ‘behavior sub-type’ to guarantee functional conformance in preparation for the case that a substituted service is selected. If a new context has no sarqe service as the existing service, the ‘behavior sub-type’ makes it possible to substitute a sub-type or a super-type for the existing service.

Accordingly, the application is flexibly connected to the same type of service that is usable in the environment and also receives a guarantee for the functional conformance. In order to relax the constraints, service providers are allowed to use either the strong or weak notion of the ‘behavior sub-typing’ in designing a new service. This means that a function newly added to the sub-type can be substituted by a combination of super-type operations or not.

If the required service does not exist in a new environment, the following three methods for adapting the service are suggested. The first method is to substitute the required service with the sub-type. The sub-type provides operations corresponding to all of the super-type's operations, so that all operations of the required service can be provided. In other words, all of the sub-types have a functional conformance with the super-type, which is referred to as ‘sub-type substitution’ hereinbelow.

The second method is to substitute the required service with the super-type. The second method is used when no sub-type of the required service exists in the new environment. This second method is divided into two further methods. One further method is to substitute the required service with the super-type. An additional operation of the sub-type is substituted with a combination of the super-type's operations. This is referred to as ‘super-type substitution’ hereinbelow. The other further method is to coerce an additional operation of the sub-type into a certain operation of the super-type. When a service provider adds a new operation to the sub-type but the new operation cannot be substituted with the combination of the super-type's operation, the service provider coerces the combination into another operation of the super-type to receive a guarantee for the functional conformance. This is referred to as ‘super-type coercion’. Information about whether to substitute or coerce the additional operation of the sub-type with a super-type's operation is described by the service providers.

That is, the service provider has to describe this information when designing a new service. The present invention suggests a method for describing this information such that it is possible to convert the required service into the super-type. However, whether to convert the required service into the super-type is determined by the policy of an application because the required service may be coerced into another operation of the super-type although the user does not intend to do so. Also, if the required service is converted into another service, mapping information about the operations of the substituted sub-type or super-type or the coerced super-type has to be provided. This is to transparently convert the required service into the three types, i.e., ‘sub-type substitution’, ‘super-type substitution’, and ‘super-type coercion’.

If a new service is designed based on the existing service, the following information has to be added to a service description provided by the service provider to support transparent service adaptability. First information describes a relationship between types, i.e., describes which service is a super-type. The first information is necessary to make a type hierarchy tree. The second information describes the operations of a service substituted for the required service's operation. This information is about whether the additional operation is substituted with or coerced into the super-type's operation when the required service is converted into the super-type. The third information describes a pre-condition and a post-condition of each of the operations of the service, and this helps the service provider to describe a substitutable service in designing a new environment. The above three types of information are described in the service description along with the functional description of the service, and are stored in a type repository 150 which will be described below.

Hereinafter, it is assumed that information about application components, i.e., information about which distributed service components configure an application and about how the service components interact with one another are transmitted to a new environment where a user moves. The interaction among the components assumes a message-based system such as publish/subscribe because the message-based system is suitable for the pervasive environment.

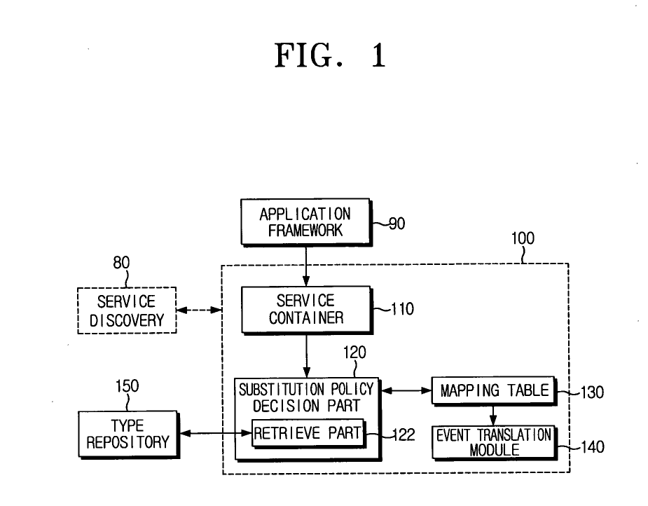

FIG. 1 is a block diagram illustrating an application reconfiguration system according to an exemplary embodiment of the present invention. Referring to FIG. 1, an application reconfiguration system comprises a service adaptation manager part 100 and a type repository 150. The service adaptation manager part 100 comprises a service container 110, a substitution policy decision part 120, a mapping table 130, and an event translation module 140. The service adaptation manager part 100 receives a request for the application program reconfiguration from an application framework 90 and processes the request. The substitution policy decision part 120 comprises a retrieve part 122.

The service container 110 stores information about an application, i.e., information about which service components configure the application, in the form of information directly indicating the components rather than in the form of the object itself. For the identity of the components, it is assumed that the application and each service thereof have a unique identifier (ID). The service container 110 stores identifier information about substituted services after the application reconfiguration so that the system is able to transparently change a message requested by a user during the execution of service.

The substitution policy decision part 120 performs the notion of behavior sub-typing. More specifically, the substitution policy decision part 120 finds service components of the application in a current environment where a user moves, using the information about the application received from the service container 110. For this, the retrieve part 122 extracts the information about the substitutable service from the type repository 150. Herein, it is assumed that there is a service discovery 80 capable of determining whether a local service exists in each environment.

The substitution policy decision part 120 performs three processes. The first process is the service discovery 80 determines whether there exists the same service as the required service in the current environment where the user moves. If there is no same service, the type repository 150 extracts information about a sub-type or a super-type from the type repository 150 and determines whether the required service exists in the current environment or if it is substitutable. The system first tries to substitute the required service with the sub-type and then tries to substitute the required service with the super-type. Finally, the information about the substituted service is stored in the mapping table 130. At this time, in order to describe operations of the required service explicitly, the ‘operation overloading’, which uses the same function name but uses a different parameter, is taken into consideration. If it is impossible to find a substitutable service through the above-described three processes, the system tries to find another sub-type to substitute for the required service or tries again to substitute the required service with the super-type. If there is no substitutable service, the system fails to reconfigure the application.

The mapping table 130 stores mapping information between the existing service and the substituted service as a result of executing the substitution policy decision part 120. The stored information indicates which service is substituted for the required service or which operation is substituted or coerced for the required service. The former is defined as ‘service mapping information’ and the latter is defined as ‘operation mapping information’. If the required service is substituted with the sub-type, only the service mapping information is stored because the sub-type provides all operations of the super-type. That is, if the required service is substituted with the sub-type, the sub-type can respond to any request from the user so that it is just required to change a destination of the message. However, if the required service is substituted with the super-type, not only the service mapping information but also the operation mapping information has to be stored because the super-type does not provide the additional operation of the sub-type. Accordingly, if the required service is substituted with the super-type, the mapping table 130 has to store information about which operation of the super-type the additional operations of the sub-type are mapped into.

As described above, different information is stored in the mapping table 130 depending on whether the required service is converted into the sub-type or super-type and also if the information to be changed is different. Therefore, for the sake of an efficient retrieving operation and an efficient system management, two repositories are provided to store different information respectively. The mapping information is used in the event translation module 140.

The event translation module 140 processes the request for service operations of respective components that appear with messages during the execution. If a message requesting an operation for the service for which sub-type or super-type was substituted, the event translation module 140 reads out information from the mapping table 130 and transparently converts the information into the message. Different ways of converting the information into the message are used on a case by case basis. If the required service is not substituted, the event translation module 140 simply transmits the message to a destination. That is, the event translation module 140 transparently processes the request from the user regardless of whether the required service is substituted.

The type repository 150 extracts information of the service. The type repository 150 extracts information about not only the type of the required service but also the sub-type or super-type. The information of the service is about all functional aspects provided by the service and about behaviors of the operations. In order to indicate the information, the type repository 150 creates a service hierarchy tree. The service hierarchy tree allows the system to create mapping information when the existing service is substituted with the sub-type or super-type.

The service hierarchy tree managed by the type repository 150 stores a relationship between the services and also stores information about the service. Herein, the service hierarchy tree does not mean a hierarchy tree of devices because a single device can provide multiple services. Accordingly, the services have their respective hierarchy trees. The service hierarchy tree is created based on the analysis of the service when a new service is registered at the type repository 150 by the service provider.

There are additional requirements to support the application reconfiguration method according to an exemplary embodiment of the present invention. First, the system has to describe which service is a super type. Second, the system has to describe which operation of the super-type is substituted or coerced for the additional operation of the service in preparation for the case that the required service is substituted with the super-type. Finally, the system has to describe the pre-condition and post-condition so as to help the service providers describe a substitutable operation for the additional operation in designing a new service. The first and the second requirements are dependent on the description of the operation.

[Table 1] shows information about the service that is stored in the service hierarchy tree. Such information is extracted from the substitution policy decision part 120 when the application is reconfigured and is used in creating the mapping table 130.

TABLE 1

```
The service name
For each operation:
  name
  arguments type list
  return type
  substitutableOperation* :
    name
    argument type list
    return type
```

In the [Table 1], the field of substitutableOperation* is a selectable field, and if an existing service is substituted with the super-type in a new environment, it stores information about which operation of the super-type is substituted or replaced for the existing service. This field describes only the additional operations of the sub-type because other operations can be provided in the super-type. As described above, since the ‘substitution’ and the ‘coercion’ are available, a value of the field of substitutableOperation* describes which case is selected, the ‘substitution’ or ‘coercion’ because the event translation module 140 supports a different process depending on the case. In addition, the field of substitutableOperation* describes a name of the substituted operation and a restore value. Even if information about a substituted operation is described, the user may not want the operation to be lowered, and thus, the system conforms to the application policy if the required service is substituted with or coerced into the super-type. Information of other field indicates respective operations of the service as its name means.

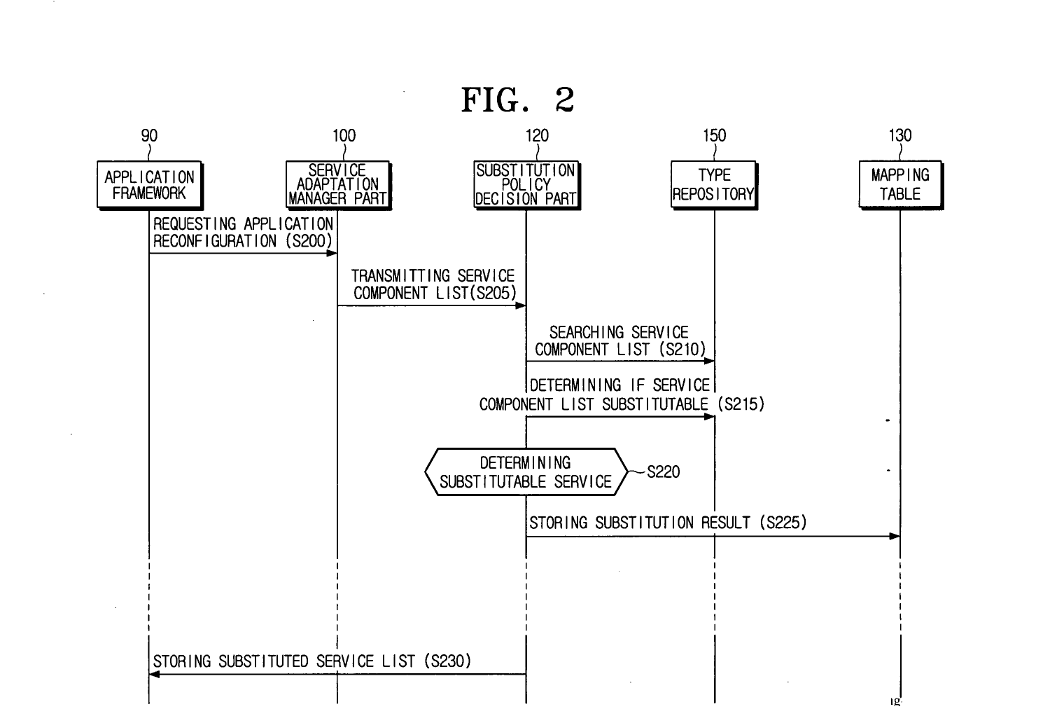

FIG. 2 is a flowchart illustrating a message transferring process to explain a method for reconfiguring an application according to an exemplary embodiment of the present invention. This message transmission occurs when a user moves to a new environment or devices or services dynamically appear.

A process of substituting a required service with a sub-type is as follows. The service adaptation manager part 100 receives a request for the application reconfiguration from the application framework 90 when a user moves to a new environment at operation S200. The service adaptation manger part 100 transmits a service component list from the service container 110 to the substitution policy decision part 120 at operation S205. The service component list includes information about an application, i.e., information about which service components configure the application.

The substitution policy decision part 120 refers to the transmitted service component list at operation S210 and determines whether each of the service components is substitutable, using the type repository 150 at operation S215, and receives service component information retrieved by the type repository 150. If the same type of service is not available, the retrieve part 122 analyzes a service hierarchy relationship of the type repository 150 and finds the sub-type. The priority of the sub-types is determined by taking a similarity between the services into consideration. The sub-type that is most similar to the existing service has a priority. The substitution policy decision part 120 checks whether the most similar sub-type exists in the current environment using the service discovery 80. If the most similar sub-type does not exist, the system tries to find another sub-type. This process continues until the most similar sub-type is found and a substitutable service is determined at operation S220.

The substitution policy decision part 120 stores a substitution result, i.e., mapping information between the existing service and the substituted service to the mapping table 130 at operation S225. The operations S210 to S225 are performed with respect to all of the components, and when the operations are completed, the substitution policy decision part 120 stores a list of the substituted services to the application framework 90 at operation S230.

The mapping table 130 stores only information about which sub-type is substituted for the required service. If no sub-type exists in the current environment, the substitution policy decision part 120 tries to substitute or coerce the required service with or into the super-type. If no super-type exists in the current environment, the system fails to reconfigure the application. As described above, whether the required service is substituted with or coerced into the super-type is determined according to a policy provided by service providers. For the substitution, the same process is performed at the beginning of process but different processes of determining whether to substitute with or coerce into the super-type are performed according to the description of the substitutable operation of the service hierarchy tree.

In order to substitute the required service with the super-type, the retrieve part 122 analyzes the service hierarchy relationship and finds the super-type for the required service. Unlike the process of converting into the sub-type, this process obtains the direct upper super-type of the required service only. This is because the service providers describe only the operation mapping information about the direct upper super-type. When the type depository 150 transfers the super type, the service discovery 80 determines whether the super-type exists in the current environment.

If the substitution policy decision part 120 determines that the additional operation of the existing service is substituted with the super-type, the substitutable operation field of the additional operation is described as a combination of the super-type functions. The description of the field is stored in the mapping table 130.

If the substitution policy decision part 120 determines that the additional operation of the existing service cannot be substituted with the super-type, the substitutable operation field of the additional operation is described as another operation of the super-type. That is, the required service is coerced into a different operation. In this case, the description of the field is stored in the mapping table 130.

In order to find a substitutable operation from the services retrieved at the service hierarchy tree, the substitution policy decision part 120 uses two retrieve methods. One retrieve method is a name-based method that finds an operation having the same name from the substitutable services. This is referred to as “syntactic matching”. If the services have the same name, parameter, and restore value, the services have the same operation. If the name-based retrieve method does not find the substitutable operation to substitute with or coerce into the super-type, a meaning-based retrieve method is used. The meaning-based retrieve method checks the information of the substitutable operation field and finds which operation the additional operation is converted into.

After reconfiguring the application to the new environment in which the user has moved, a process of converting a message from a user is required in executing the application. During conversion of a message, in order to transparently transmit the message requested by the user, the service container 110 determines whether the required service is substituted in the new environment. If the required service is not substituted, the request from the user is transmitted to the event translation module 140 and the event translation module 140 publishes an event. However, if the required service is substituted with another service, the required service is transmitted to the mapping table 130 so that the mapping table 130 can determine which service substitutes the required service. The mapping table 130 transmits the information to the event translation module 140. The destination of the message, and if necessary, the message itself are converted into another message according to the information transmitted from the event translation module 140, and the converted message is transmitted to a changed destination.

Of course, a user's requirement of a specific operation of service is included in the message. The event translation module 140 performs the following three processes based on the contents described by the mapping table 130. If the required service is substituted with the sub-type, only the destination of the transmitted event is changed. If the required service is substituted with the super-type, the destination is only changed with respect to the operations supported by the super-type and the original service. However, if an additional operation of the existing service is required, the combination of the super-type's operations are processed in sequence according to the description of the mapping table 130 in order to maintain the service conditions, before the operation is executed and after the operation is executed, equal, i.e., in order to maintain the pre-condition and the post-condition of the service. If the required service is substituted with the super-type, the required service is simply converted into one of the super-type's operations according the mapping table 130.

For example, it is assumed that a service called “Light” exists in a current environment. The service “Light” is a super-type of a service called “Smart light” and performs two operations “turn-on” and “turn off”. The service “Smart light” extends the service “Light” and thus provides a function “dimming”. The function “dimming” is realized by adding a parameter “dim-level” to the operation “turn on”. If the service “Light” does not exist and only the service “Smart light” exists in a new environment where the user has moved, the service “Light” is substituted with the service “Smart light”.

If the user requests the operations “turn on” and “turn on” of the service “Light”, two operations are transparently substituted with the operation “turn on” and “turn off” of the service “Smart light”. On the other hand, it is assumed that the user uses the service “Smart light” in the existing environment.

If the user moves to a new environment where only the service “Light” is available, the service “Smart light” is substituted with the service “Light” on the assumption that the service “Smart light” does not exist in the new environment and no sub-type of the service “Smart light” exists. The function “dimming” of the service “Smart light” is coerced into the function “turn on” of the service “Light” because the function “dimming” cannot be substituted with a combination of the functions of the service “Light”. The function “dimming” of the service “Smart light” required by the user is transparently converted into the operation “turn on” of the service “Light”.

The application reconfiguration system according to an exemplary embodiment of the present invention is realized by Java. The type repository 150 is realized using the Java and extensible markup language (XML). In the present invention, a tag is added to the web service description language (WSDL) which provides only an operational description, and the service is described in a language similar to the WSDL. The advantage of the WSDL is that the method according an exemplary embodiment of the present invention is easily applied to the service described in the existing WSDL by adding a few tags to the WSDL. The service description results in the service hierarchy tree storing the relationships and information of the services. In order to analyze the service description, a Java WSDL (WSDL parser) is extended. The extended JWSDL analyzes the information of the service when the service is registered at the type repository. In order to show the relationship between the services at the service hierarchy tree explicitly, a document object model (DOM) is used. The DOM apparently shows a hierarchy relation model and provides a platform and language-neutral interface.

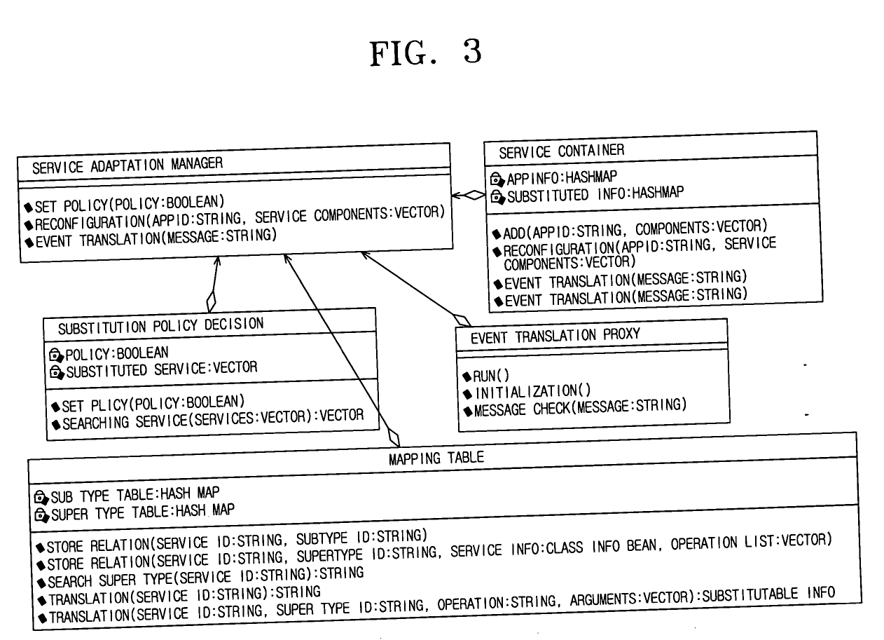

FIG. 3 is an entire class diagram used in the application configuration system according to an exemplary embodiment of the present invention. The application framework 90 makes a request for an application reconfiguration by calling a reconfiguration of the service adaptation management part 100. At this time, the substitution policy decision part 120 reads the information about the respective services from the type repository 150 using the function of searching services and identifies whether a substitutable service exists in the current environment. This process is repeated a predetermined number of times that corresponds to the number of components of the application. After reconfiguration, a list of the substituted services is stored in the service container 110 by using the function of setSubstitutionInfo.

The mapping table 130 may be embodied by one of two hash tables depending on which service is substituted for the required service. These two hash tables store information about the case that the required service is substituted with the sub-type and about the case that the required service is substituted with the super-type. The sub-type hash table stores a service value that corresponds to a key substituted for the existing service. Since the super-type table has to store additional data such as a parameter or a restore value of the substituted operation, it stores an abstracted class where the existing service is inserted as a key and the operation of the substituted service is stored as a value.

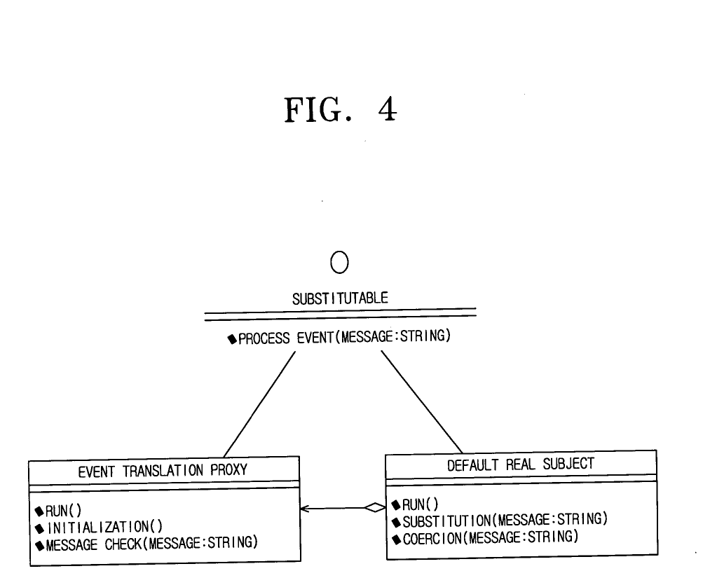

FIG. 4 is a class diagram of the event translation module 140 of FIG. 1. As shown in FIG. 4, the event translation module 140 may be embodied in a proxy model. The two classes implement a process event interface of a substitutable interface, thereby enabling a user to transparently drive the application in the new environment by paging the process event interface although the user is unaware of whether the service is substituted or not.

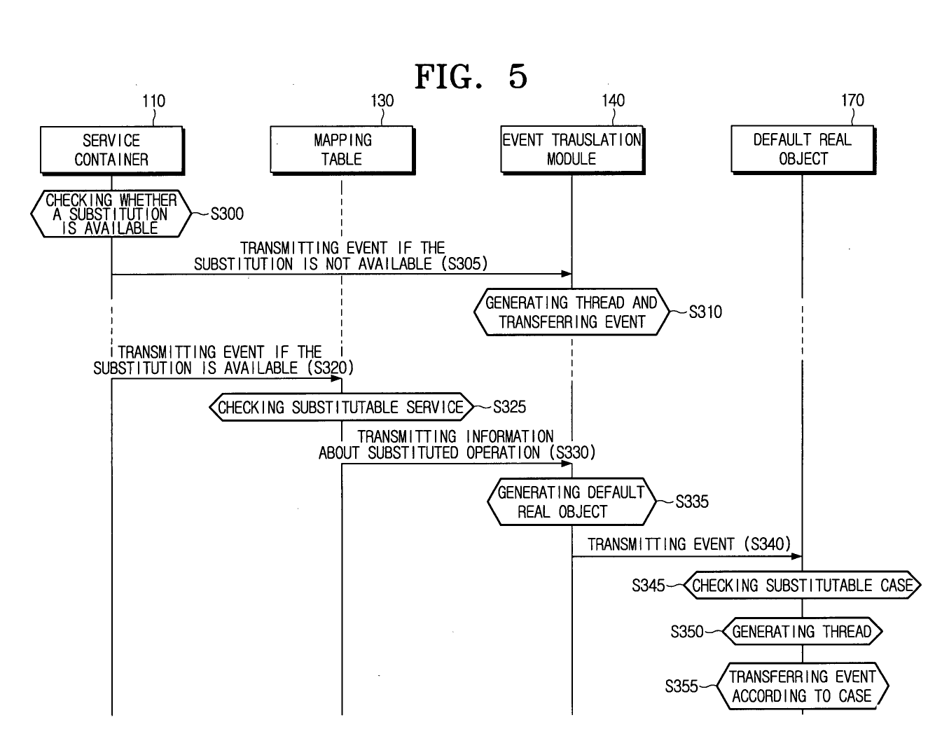

When the user transmits an event to an event translation proxy through the process event interface, the classes check the content of the event, and if the required service is not substituted, promptly send the event, and if the required service is substituted, generate a default real object and turn the event process over to the default real object. The default real object changes the content of the event according to the description of the mapping table and transmits the changed content. The two classes are embodied in a multi-thread method to process many requests simultaneously in real time. That is, one thread is generated at every request from a user and process of the event. FIG. 5 is a flowchart illustrating a message transferring process of the event translation module of FIG. 1 Referring to FIG. 5, the service container 110 determines whether the required service is substitutable at operation S300. That is, in order to transparently transmit the message requested by the user, the service container 110 determines whether the required service is substituted in the new environment.

If the substitution is not available, the service container 110 transmits the event to the event translation module 140 at operation S305. That is, if the required service is not substitutable in the new environment, the service container 110 transmits the request from the user to the event translation module 140.

The event translation module 140 generates a thread and transmits the received event to a target destination at operation S310. That is, the event translation module 140 checks the content of the event, and if it is impossible that the required service is substituted, transmits the message requested by the user to the target destination promptly.

If the substitution is available, the service container 110 transmits the event to the mapping table 130 at operation S320. That is, the service container 110 transmits the event to the mapping table 130 to determine which service substitutes the required service.

The mapping table 130 checks the content of the received event and checks whether the service required by the user is substituted at operation S325.

The mapping table 130 transmits information about the substituted function to the event translation module 140 at operation S330.

The event translation module 140 generates a default real object 170 and transmits the event to the default real object 170 at operation S340.

The default real object 170 checks a substitutable case, generates a thread, and transmits the event according to the substitutable case at operations S345, S350 and S355. That is, the default real object changes the content of the event according to the description of the mapping table 130 and transmits the changed content.

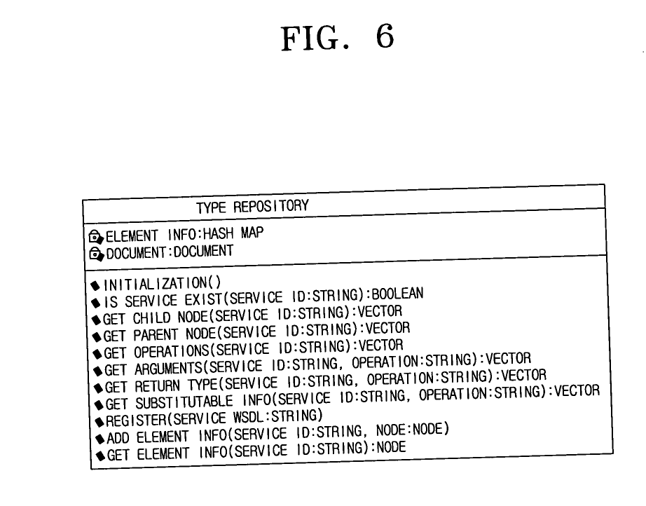

FIG. 6 is a class diagram of the type repository 150 of FIG. 1. The type repository 150 has two parsers: one parser analyzes a service hierarchy tree; and the other parser analyzes an extended WSDL and embodied by extending the JWSDL. The type repository 150 has a hash table that stores the names of services and an index of services within the service hierarchy tree in order to reduce a time required to analyze the service information in the service hierarchy tree. Due to the presence of the hash table, it takes a constant amount of time to retrieve the services even if the kinds of services increase. The class diagram of FIG. 6 illustrates application program interfaces provided by the type repository 150.

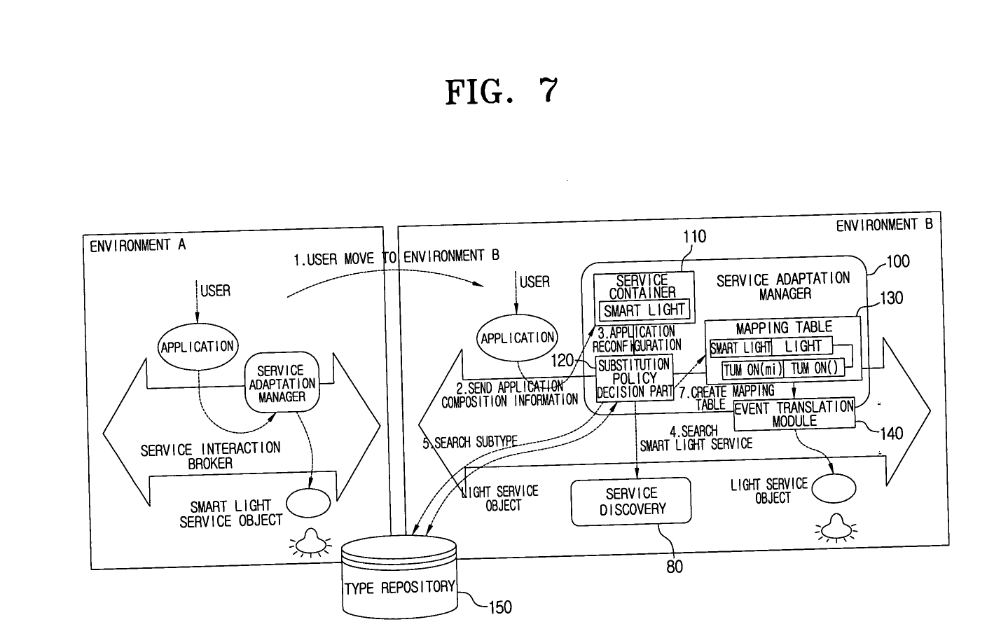

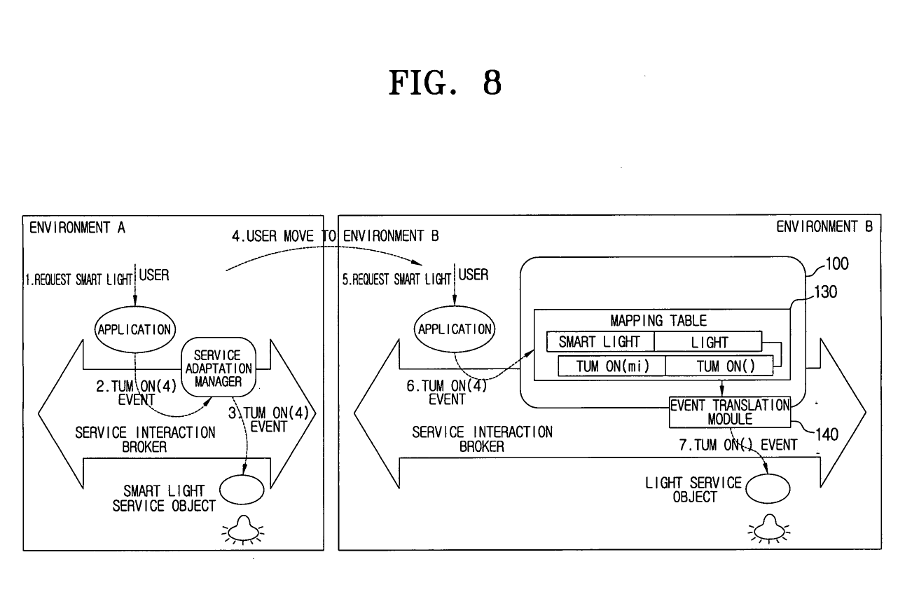

FIGS. 7 and 8 are views illustrating an example case where the application reconfiguration method is applied to a smart light service according to an exemplary embodiment of the present invention. FIG. 7 illustrates an application reconfiguring process when a user using a smart light service moves from an environment A to a new environment B. FIG. 8 illustrate an interaction between the environments A and B after the user moves from the environment A to the environment B and the application is reconfigured.

As illustrated in the above example, the application reconfiguration method according to an exemplary embodiment of the present invention uses only the hierarchy relationship between the service types in order to find a substitutable service efficiently. That is, only the relationship between the services is taken into account when finding a substitutable service. The method according to an exemplary embodiment of the present invention therefore does not require a detailed description of a service and effectively programs the system. Also, the present invention differs from a conventional method for extending the notion of sub-type in that the required service is substituted with both the sub-type and the super type based on the effectiveness of the service in the respective environment.

According to the exemplary embodiment of the present invention as described above, the main object of the pervasive computing is achieved such that the system is adapted to a dynamically changing environment for a user's convenience and thus enables a user to concentrate on his/her own work. For this, the application of the pervasive environment is dynamically and transparently adapted to the change in the context when the user moves to other environments or devices or services dynamically appear. According to an exemplary embodiment of the present invention, even if there is no same service as the existing service in a new environment where a user moves, the application is transparently reconfigured with the sub-type or super-type substituted for the required service based on the notion “sub-typing”. Also, the method according to the present invention applies the notion “behavior sub-typing” and thus guarantees flexibility and function conformance.

The foregoing embodiments and advantages are merely exemplary and are not to be construed as limiting the present invention. The description of the present invention is intended to be illustrative, and not to limit the scope of the claims. Many alternatives, modifications, and variations will be apparent to those skilled in the art.

What is claimed is:

1. A method for reconfiguring an application in a pervasive computing environment, the method comprising:
receiving a request for a reconfiguration of a predetermined application reconfiguration according to a change in a context;
searching for a service in response to the change in the context with respect to each of at least one service component configuring the predetermined application; and
reconfiguring the predetermined application based on the searched service.

2. The method as claimed in claim 1, wherein searching for the service comprises:
searching for a service that provides the same operation as that of the service component; and
if there is no service providing the same operation as that of the service component, searching for a substitutable service.

3. The method as claimed in claim 2, wherein the substitutable service is based on a ‘behavior sub-typing’ notion, and the substitutable service is determined according to one of a substitution with a sub-type method, a substitution with a super-type method, and a coercion with a super-type method.

4. The method as claimed in claim 1, wherein the change in the context occurs due to one of a user moving to a new environment, a device dynamically appearing, and a service dynamically appearing.

5. An application reconfiguration system which reconfigures an application according to a change in a context in a pervasive computing environment, the system comprising:
a service container which stores information about at least one service component configuring a predetermined application;
a substitution policy decision part which searches for service information in response to the change in the context with respect to the at least one service component; and
a mapping table which stores mapping information between the service component and the corresponding service information.

6. The application reconfiguration system as claimed in claim 5, further comprising a type repository which stores information necessary to search the service information.

7. The application reconfiguration system as claimed in claim 5, further comprising an event translation module which processes a request for an execution of the predetermined application according to the mapping information stored in the mapping table.

8. The application reconfiguration system as claimed in claim 5, wherein the substitution policy decision part searches for a service that provides a same operation as that of the service component, and if there is no service providing the same operation as that of the service component, searches for a substitutable service.

9. The application configuration system as claimed in claim 5, further comprising a service discovery which determines whether a new location to which a user has moved has a same service component as a previous location of the user.

10. The application reconfiguration system as claimed in claim 8, wherein the substitutable service is based on a ‘behavior sub-typing’ notion, and the substitutable service is determined according to one of a substitution with a sub-type method, a substitution with a super-type method, and a coercion with a super-type method.

11. The application reconfiguration system as claimed in claim 5, wherein the change in the context occurs due to one of a user moving to a new environment, a device dynamically appearing, and a service dynamically appearing.
